(19) United States
(12) Patent Application Publication
(10) Pub. No.: US 2010/0251166 A1
(43) Pub. Date: Sep. 30, 2010

(54) INFORMATION BROWSE APPARATUS

(75) Inventor: Kazuki MATSUI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/732,279

(22) Filed: Mar. 26, 2010

(30) Foreign Application Priority Data
Mar. 30, 2009 (JP) 2009-082398

(51) Int. Cl. G06F 3/048

(52) U.S. Cl. 715/784

(57) ABSTRACT

An information browse apparatus includes an attractive data detector, a display unit, a scroll processor, and a data clipper. The attractive data detector detects attractive data and a location of the attractive data. The display unit displays partial data of spread data on a display area corresponding to a screen size of a display screen. The scroll processor determines a direction and speed of scrolling in response to a scroll instruction, determines a basic updated location of an updated display area in accordance with the direction and speed of scrolling, and determines a corrected updated location in accordance with the location of the attractive data and the basic updated location. The data clipper clips the partial data of the spread data to be displayed on the display unit.

### CROSS-REFERENCE TO RELATED APPLICATION

This application is based upon and claims the benefit of priority of the prior Japanese Patent Application No. 2009-082398, filed on Mar. 30, 2009, the entire contents of which are incorporated herein by reference.

### FIELD

The embodiments discussed herein are related to an information browse apparatus, and in particular to a control method for controlling display of information on a mobile apparatus having a small-sized display screen.

### BACKGROUND

Mobile apparatuses such as a mobile phone, a personal digital assistant (PDA), and a smart-phone have been mounted with a World Wide Web (web) browser (commonly known as a full browser) which enables a rich content for a personal computer (PC) to be browsed. The full browser allows users to browse a rich content for PC instead of a content customized for a mobile apparatus and to collect information through the Internet by using a mobile apparatus similarly to a PC.

When a web content for a PC is browsed, a scroll display may be employed. As a method for helping to read scroll-displayed information, it has been proposed to change the scroll speed in response to a key word included in a displayed content. For example, the scroll speed is lowered when displaying a description including a specific key word, or the scroll speed is changed in accordance with the type of a content being displayed. Lowering the scroll speed of the important information may reduce the cases in which the user misses important information.

Japanese Laid-open Patent Publication No. 2002-82664 discloses a related technique.

Since a high-resolution display such as Extended Video Graphics Array (XVGA: 1024×768 pixels) is used in a PC, the user may browse the web content without problem even when a complicated and variety web content is displayed as it is.

On the other hand, many of mobile apparatuses are small so as to be easily carried, and in many cases, the display screen has a resolution of about Quarter Video Graphics Array (QVGA: 320×240 pixels) or Video Graphics Array (VGA: 640×480 pixels).

Since a mobile apparatus has a screen smaller than that of a PC, it may be necessary to scroll in the vertical direction and the horizontal direction when a web content for PC is browsed on a mobile apparatus, and it may be impossible to see the entire content by scrolling only in one direction. Consequently, there is an inconvenience that important information may not be displayed. Further, there is also an inconvenience that information which the user wants to skip may be displayed.

### SUMMARY

Accordingly, it is preferable to provide a method which reduces such an inconvenience and helps the user to read scroll-displayed information.

According to an aspect of the present invention, provided is an information browse apparatus for displaying information to be browsed. The information browse apparatus includes an attractive data detector, a display unit, a scroll processor, and a data clipper.

The attractive data detector detects attractive data preliminarily specified and a location of the attractive data within spread data to be displayed on a virtual screen supposed for display information of the information to be browsed.

The display unit displays partial data of the spread data on a display screen smaller than the virtual screen, the partial data being the spread data on a display area corresponding to a screen size of the display screen.

The scroll processor determines a direction and speed of scrolling in response to a scroll instruction to the information displayed on the display unit, determines a basic updated location of an updated display area in accordance with the direction and speed of scrolling, the updated display area replacing a current display area, the spread data on the current display area being currently displayed, and determines a corrected updated location in accordance with the location of the attractive data and the basic updated location.

The data clipper clips, in accordance with the corrected updated location, the partial data of the spread data to be displayed on the display unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of an information browse apparatus according to an embodiment of the invention;

FIG. 2 is a diagram illustrating an example of a detailed configuration of a scroll processor of an information browse apparatus according to an embodiment of the invention;

FIG. 3 is a diagram illustrating an example of an operation flow of a web page display process executed by an information browse apparatus according to an embodiment of the invention;

FIG. 4 is a diagram illustrating an example of an operation flow of a scroll process executed by an information browse apparatus according to an embodiment of the invention;

FIG. 5 is a diagram illustrating an example of an instruction to start scrolling in an information browse apparatus according to an embodiment of the invention;

FIG. 6 is a diagram illustrating an example of a process of determining a basic updated location executed by an information browse apparatus according to an embodiment of the invention;

FIG. 7 is a diagram illustrating an example of a description of attractive data in an information browse apparatus according to an embodiment of the invention;

FIG. 8 is a diagram illustrating an example of a process of calculating an attractive force executed by an information browse apparatus according to an embodiment of the invention;

FIG. 9 is a diagram illustrating an example of a process of correcting an updated location executed by an information browse apparatus according to an embodiment of the invention;

FIG. 10 is a diagram illustrating an example of a detailed configuration of a scroll processor of an information browse apparatus according to an embodiment of the invention; and

FIG. 11 is a diagram illustrating an example of a process of correcting an updated location executed by the information browse apparatus according to an embodiment of the invention.

### DESCRIPTION OF EMBODIMENTS

According to an aspect of the invention, it becomes easy for the user to read scroll-displayed information since important information becomes easy to be displayed, or needless information becomes difficult to be displayed by correcting an orbit of scrolling in response to existence of specific information.

Hereinafter, embodiments of the invention will be discussed with reference to the drawings.

### First Embodiment

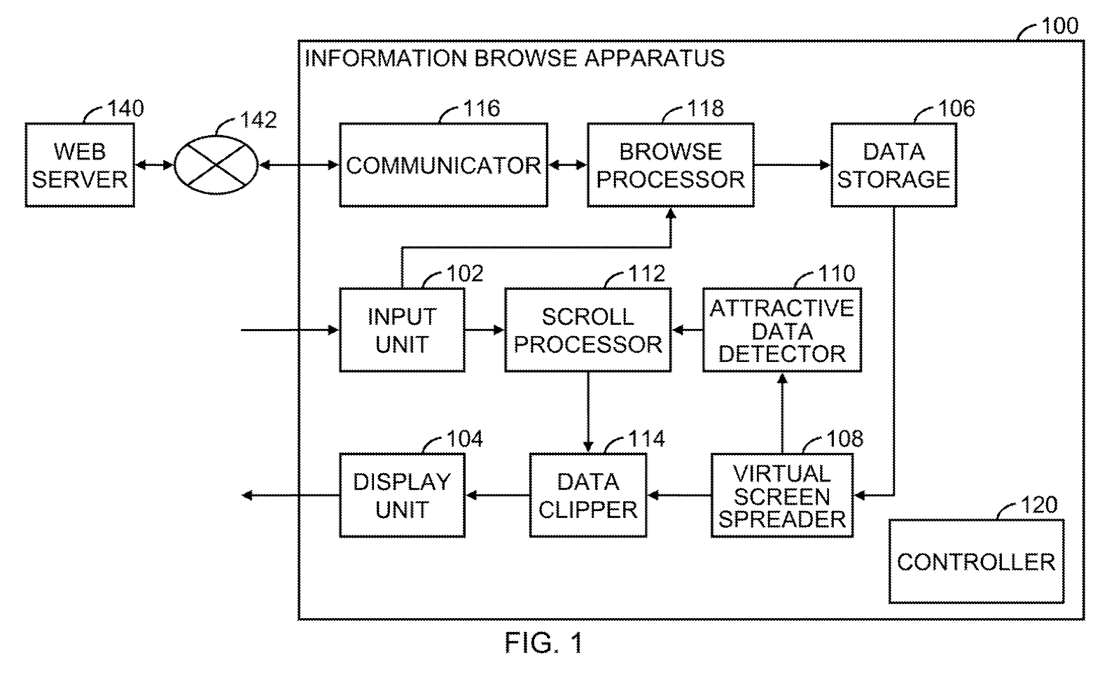

FIG. 1 is a diagram illustrating an example of a system configuration of an information browse apparatus according to an embodiment of the invention. As illustrated in FIG. 1, the information browse apparatus 100 includes an input unit 102, a display unit 104, a data storage 106, a virtual screen spreader 108, an attractive data detector 110, a scroll processor 112, a data clipper 114, a communicator 116, a browse processor 118, and a controller 120. The information browse apparatus 100 communicates with a web server 140 through a communication network 142.

The input unit 102 receives input information input from the user and transmits the input information to the scroll processor 112.

The data storage 106 stores display information of the information to be browsed. For example, the data storage 106 temporarily stores display information of a web page received through the Internet as discussed below.

The virtual screen spreader 108 generates spread data to be displayed on a virtual screen supposed to be, for example, a PC screen in accordance with the display information stored in the data storage 106.

When the spread data created by the virtual screen spreader 108 includes attractive data which is preliminarily specified, the attractive data detector 110 detects the attractive data and a location, in the spread data, of the attractive data.

The display unit 104 has a display screen smaller than the virtual screen. The display unit 104 displays partial data of the spread data on the display screen. The partial data is the spread data on a display area corresponding to a screen size of the display screen.

The scroll processor 112 determines a location of an updated display area. The updated display area is a display area that replaces a current display area. The spread data on the current display area is currently displayed.

The data clipper 114 clips the partial data, which corresponds to the updated display area, of the spread data to be displayed on the display unit and displays the clipped data on the display unit 104.

The communicator 116 is an interface via which the information browse apparatus 100 communicates or speaks through the communication network 142. In the first embodiment, the communicator 116 transmits a reference request for a web page to the web server 140 in response to the instruction form the browse processor 118. Further, the communicator 116 receives data of a web page transmitted from the web server in response to the reference request for the web page.

The browse processor 118 executes operations of a full browser. The browse processor 118 receives, via the input unit 102, a uniform resource locator (URL) or the like of a web page that the user wants to browse. The browse processor 118 obtains display information of the web page from the web server 140 via the communicator 116 in accordance with the received URL of the web page. The obtained display information of the web page is temporarily stored in the data storage 106.

The controller 120 controls the entire information browse apparatus 100. Among functions performed by the information browse apparatus 100, functions that are not explicitly discussed in the specification may be performed by the controller 120.

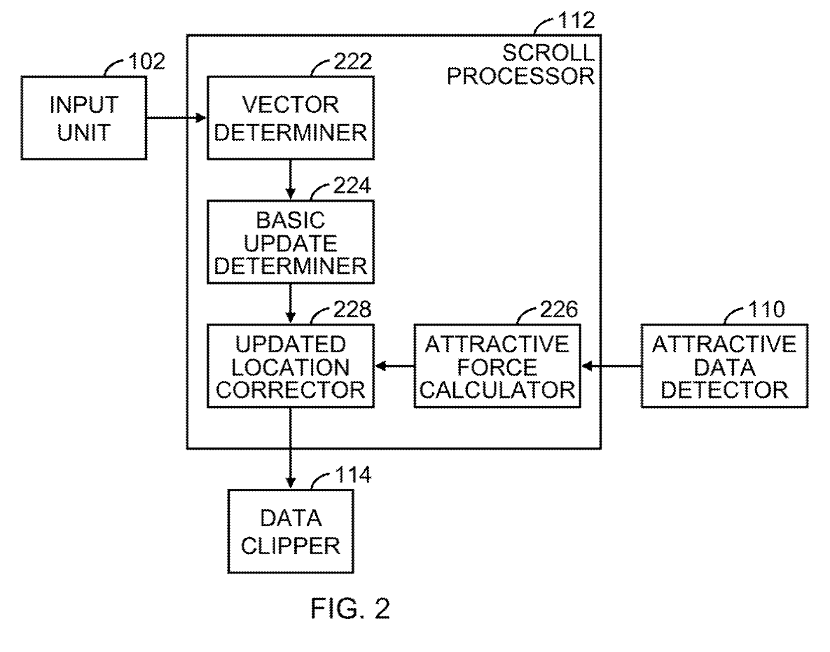

FIG. 2 is a diagram illustrating an example of a detailed configuration of a scroll processor of an information browse apparatus according to an embodiment of the invention. As illustrated in FIG. 2, the scroll processor 112 includes a vector determiner 222, a basic update determiner 224, an attractive force calculator 226, and an updated location corrector 228.

The vector determiner 222 determines a direction and speed of scrolling.

The basic update determiner 224 determines a basic updated location of an updated display area in accordance with a location of the display area when the scrolling has been started, an elapsed time from starting the scrolling, and the direction and speed of scrolling. The updated display area replaces a current display area. The spread data on the current display area is currently displayed. The basic updated location is an updated location of the display area determined without considering the influence of the attractive data.

The attractive force calculator 226 calculates an attractive force in accordance with a distance between the basic updated location of the calculated display area and the location of the attractive data. The attractive force indicates intensity of the influence, by the attractive data, applied to the updated location of the display area.

The updated location corrector 228 calculates a corrected updated location of the display area in accordance with the determined basic updated location of the display area and the calculated attractive force. The corrected updated location is an updated location of the display area changed from the basic updated location under the influence of the attractive force.

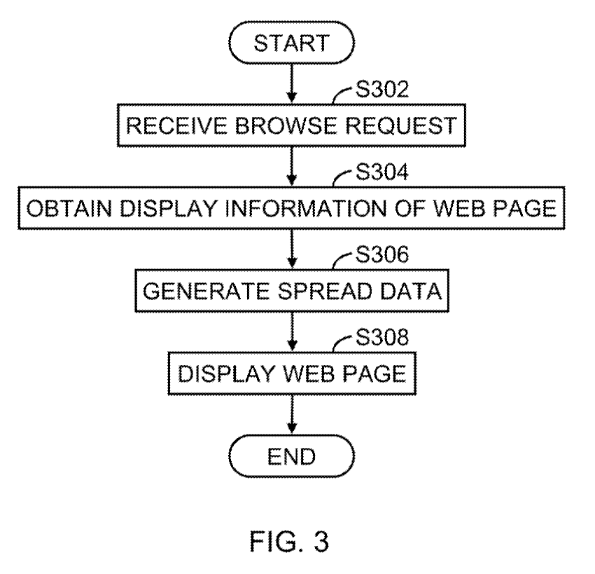

FIG. 3 is a diagram illustrating an example of an operation flow of a web page display process executed by an information browse apparatus according to an embodiment of the invention. The operation flow of the web page display process executed by the information browse apparatus 100 according to the first embodiment of the invention will be discussed with reference to FIG. 3.

In operation S302, the input unit 102 receives a browse request for a web page from the user and transmits a specified URL to the browse processor 118.

In operation S304, the browse processor 118 obtains display information of the web page from the web server 140 via the communicator 116 in accordance with the specified URL. The browse processor 118 stores the obtained display information of the web page in the data storage 160.

In operation S306, the virtual screen spreader 108 generates spread data in accordance with the display information stored in the data storage 106.

In operation S308, the data clipper 114 clips partial data of the spread data on a predetermined display area (for example, upper left area of the spread data) and displays the clipped data on the display unit 104.

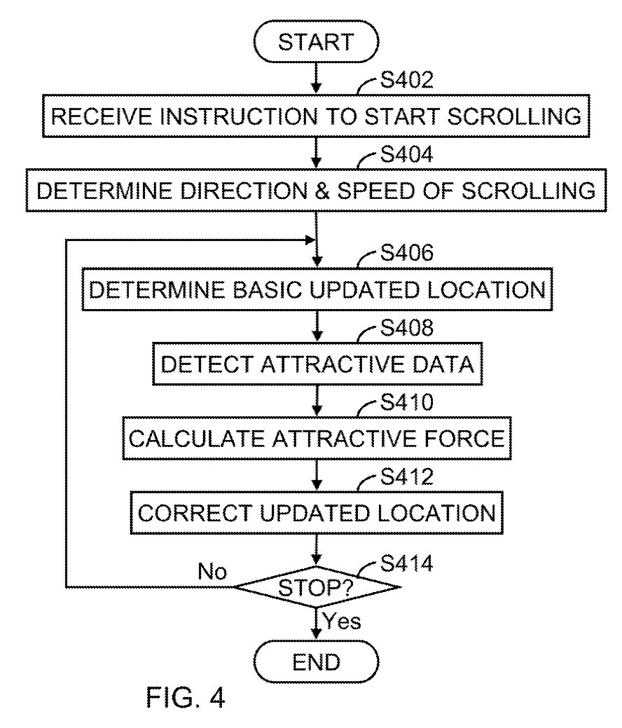

FIG. 4 is a diagram illustrating an example of an operation flow of a scroll process executed by an information browse apparatus according to an embodiment of the invention. The operation flow of the scroll process executed by the information browse apparatus 100 according to the first embodiment of the invention will be discussed with reference to FIG. 4.

In operation S402, the input unit 102 receives an instruction to start scrolling from the user. As an instruction to start scrolling, for example, the user may specify the direction and speed of scrolling by gesturing, on a touch panel mounted on the display screen, for drawing a line by a finger or a pen (referred to as a touch pen) for the touch panel. The input unit 102 transmits the input information input by the user to the vector determiner 222.

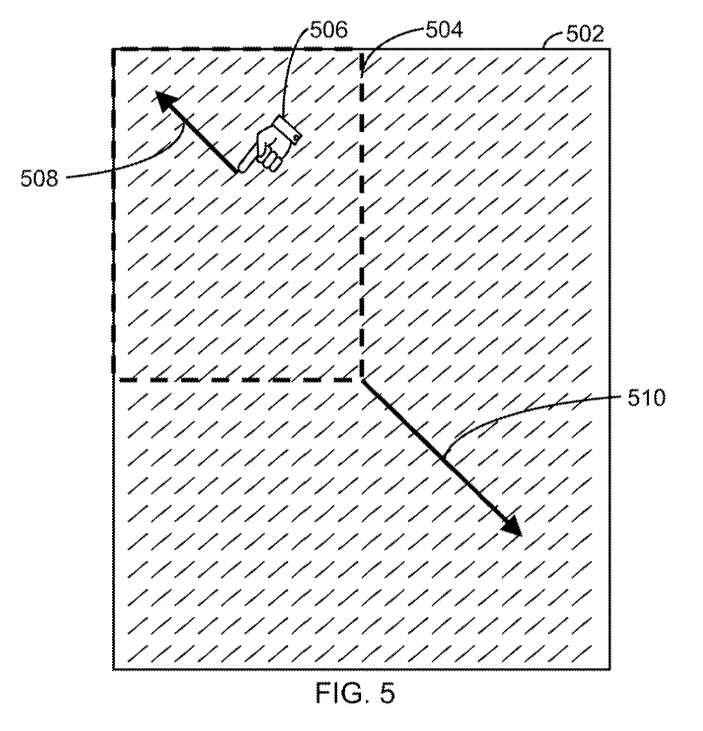

In operation S404, the vector determiner 222 determines the direction and speed of scrolling in accordance with the input information input by the user. FIG. 5 is a diagram illustrating an example of an instruction to start scrolling in an information browse apparatus according to an embodiment of the invention. The instruction to start scrolling in the information browse apparatus 100 according to the first embodiment of the invention will be specifically discussed with reference to FIG. 5.

The virtual screen spreader 108 generates spread data 502 in accordance with the display information stored in the data storage 106. When the spread data 502 is initially displayed on the display screen, for example, partial spread data on an upper left area, that is, a display area 504 is displayed. The user moves his finger 506 in the direction indicated by an arrow 508 on the touch panel mounted on the display screen as an instruction to start scrolling. The vector determiner 222 regards the direction from the starting point to the ending point of the line as the direction of scrolling and regards the value obtained by dividing the distance from the starting point to the ending point of the line by a moving time (the time from when the user touches the panel to when the user withdraws his finger from the panel) as the speed of scrolling. The starting point of the scrolling may be a current display area. Accordingly, the scroll processor 112 moves the display area 504 of the spread data 502 in a direction indicated by an arrow 510 that is opposite direction of the arrow 508. Alternatively, instead of the instruction from the user, the direction and speed of scrolling may be determined by a preliminarily set default value.

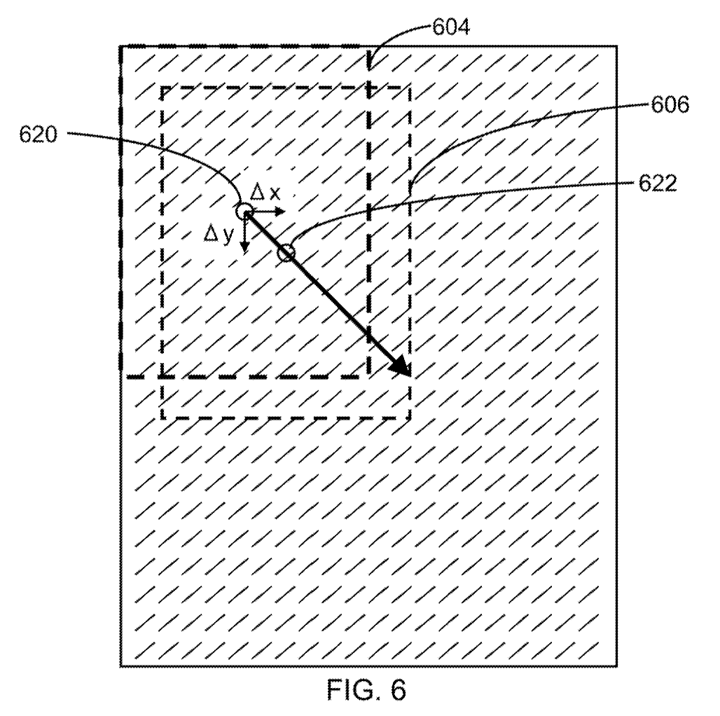

In operation S406, the basic update determiner 224 determines the basic updated location of the display area in accordance with the determined direction and speed of scrolling. FIG. 6 is a diagram illustrating an example of a process of determining a basic updated location executed by an information browse apparatus according to an embodiment of the invention. When the display area is updated once, a median point 620 of a display area 604 is shifted by a value (Δx, Δy) determined by the direction and speed of scrolling. Accordingly, the display area after the basic update becomes a display area 606 having a median point 622. N-times update causes the basic updated location of the display area to shift by (Δx*on, Δy*n) from the starting point of the scrolling.

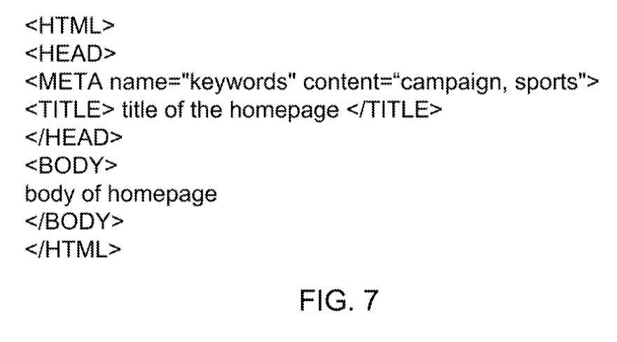

In operation S408, the attractive data detector 110 detects attractive data included in the display information, and determines the location of the attractive data in the spread data. The attractive data is data that, for example, the creator of the web page wants the reader to pay attention to. The creator of the web page describes the attractive data in a HyperText Markup Language (HTML) document of the web page. FIG. 7 is a diagram illustrating an example of a description of attractive data in an information browse apparatus according to an embodiment of the invention. The attractive data detector 110 detects the attractive data in accordance with the description.

The user may define specific data as attractive data. In this case, the user describes attractive data information in an attractive data configuration file by using a preliminarily prepared tool for defining attractive data or an editor and stores the described attractive data configuration file in a predetermined directory. The attractive data detector 110 reads the attractive data configuration file from the predetermined directory and executes a process of detecting the attractive data.

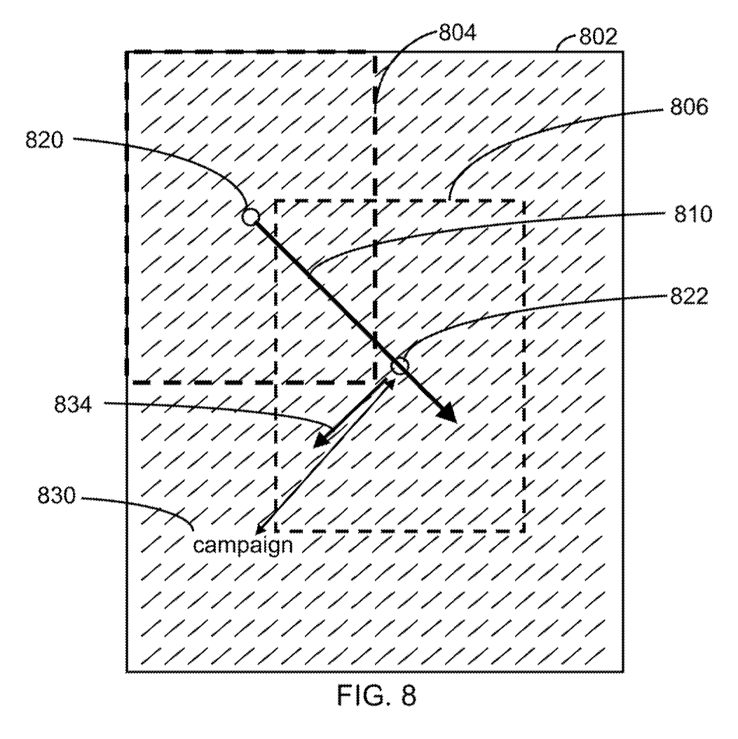

In operation S410, the attractive force calculator 226 calculates an attractive force caused by detected attractive data. FIG. 8 is a diagram illustrating an example of a process of calculating an attractive force executed by an information browse apparatus according to an embodiment of the invention. Suppose that a display area 804 of a spread data 802 is scrolled in the direction of an arrow 810. By n-times update, the basic updated location of the display area 804 comes to the location of a display area 806. A median point 820 of the display area 804 moves to the location of a median point 822 of the display area 806. The attractive force calculator 226 calculates the value of the attractive force (indicated by an arrow 834 in FIG. 8) in accordance with the distance between the median point of a detected attractive data 830 (a character string “campaign” in the example illustrated in FIG. 8) and the median point 822 of the display area 806. It is preferable to define the value of the attractive force so that the value of the attractive force becomes larger as the distance between the median point of the attractive data 830 and the median point 822 of the display area 806 becomes smaller. For example, the value of the attractive force may be defined as the value that is inversely proportional to the distance between the median point of the attractive data 830 and the median point 822 of the display area 806.

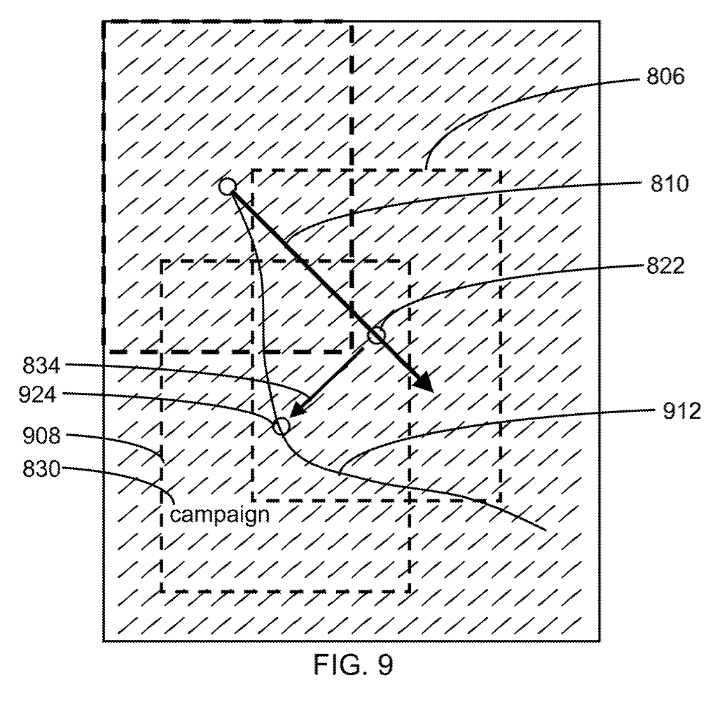

In operation S412, the updated location corrector 228 calculates a corrected updated location of the display area in accordance with the basic updated location of the calculated display area and the calculated value of the attractive force to correct the location of the updated display area. FIG. 9 is a diagram illustrating an example of a process of correcting an updated location executed by an information browse apparatus according to an embodiment of the invention. The updated location corrector 228 corrects the location of the median point 822 of the display area 806 to come close to the median point of the attractive data 830. The updated location corrector 228 moves the median point 822 of the display area 806, for example, to come close to the attractive data 830 along the direction of the arrow 834 perpendicular to the arrow 810. It is preferable to set the moving amount larger as the value of the attractive force becomes larger. For example, the moving amount may be set so as to be proportional to the value the attractive force. As a result, the location of a display area 908 having a median point 924 becomes a corrected updated location of an updated display area with n-times update. Thus, the orbit of the median point of the updated display area is changed to an orbit 912 from an orbit along the arrow 810.

In operation S414, the scroll processor 112 checks whether the user has instructed to stop the scrolling. When the user has instructed to stop the scrolling (“Yes” in operation S414), the scroll processor 112 terminates the process. When the user has not instructed to stop the scrolling (“No” in operation S414), the scroll processor 112 returns the process to operation S406. The user may instruct to stop the scrolling by, for example, lightly touching the touch panel.

The attractive data in the aforementioned example is a character string. However, the attractive data is not limited to a character string, but may also be a chart or a photograph. When a chart or a photograph is used as the attractive data, the attractive data may be defined, for example, by a key word attached to the chart or the photograph, and the value of the attractive force may be calculated in accordance with the distance between the median point of the chart or the photograph and the median point of the display area.

The attractive force may be replaced with a repulsive force. For example, the user may define data that the user wants to avoid as execrable data by the similar method as the definition of the attractive data. The attractive data detector 110 detects execrable data. The attractive force calculator 226 calculates the value of the repulsive force caused by the execrable data by the similar calculation method to that of the value of the attractive force. The updated location corrector 228 corrects the location of the updated display area so as to be farther away from the execrable data as the value of the repulsive force becomes larger. For example, the median point 822 of the display area 806 illustrated in FIG. 8 may be moved so as to be away from the attractive data 830 along the opposite direction of the arrow 834 in accordance with the value of the repulsive force. Thus, a scroll orbit avoiding the execrable data may be obtained.

As discussed above, according to the first embodiment of the invention, since the orbit of scrolling is corrected in response to the existence of attractive data or execrable data, such scrolling may be possible that important or noteworthy information may be easy to be displayed and that needless information may be difficult to be displayed. By modifying the orbit of scrolling so that attractive data is substantially included in the display area, it becomes easy for the user to recognize the attractive data, and to browse the attractive data.

In the aforementioned example, the touch panel is used for inputting the direction of scrolling. However, any input means may be employed as far as the user may specify the direction of scrolling. For example, the user may instruct to scroll by, for example, declining a device mounted with a gyro sensor, or by swinging a device mounted with an acceleration sensor.

In the first embodiment, the orbit of scrolling is changed in accordance with the location of attractive data. In addition, the speed of scrolling may be slowed down in accordance with the location of attractive data.

### Second Embodiment

Further to the first embodiment, the value of the attractive force may be changed by an instruction from the user in a second embodiment of the invention. The system configuration of an information browse apparatus according to the second embodiment is similar to the system configuration of the information browse apparatus according to the first embodiment illustrated in FIG. 1. However, it is supposed that the input unit 102 receives not only location information, but also a value of intensity of pressing the touch panel in the second embodiment. The user may continuously press the touch panel with his finger during the scrolling, and withdraw his finger from the touch panel to stop the scrolling.

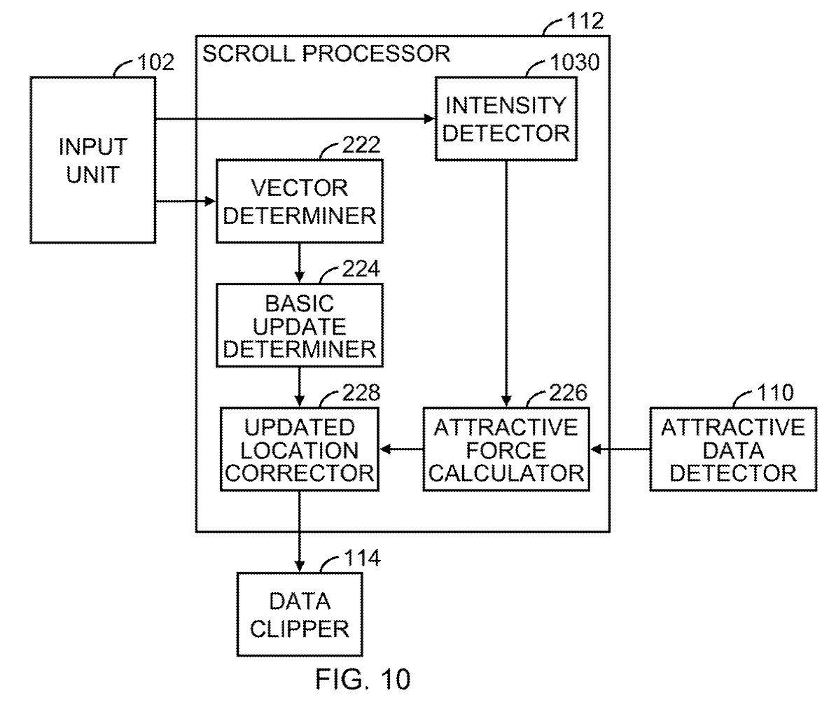

FIG. 10 is a diagram illustrating an example of a detailed configuration of a scroll processor of an information browse apparatus according to an embodiment of the invention. An intensity detector 1030 is added to the example of the detailed configuration of the scroll processor 112 of the information browse apparatus 100 according to the first embodiment illustrated in FIG. 2. The intensity detector 1030 obtains a value, included in input information, of intensity of pressing the touch panel.

An operation flow of a scroll process executed by an information browse apparatus according to the second embodiment is similar to the operation flow of the scroll process executed by the information browse apparatus according to the first embodiment illustrated in FIG. 4. However, details of some operations are different from that of the first embodiment. The operations different from that of the first embodiment will be discussed in detail, and the similar operations to the first embodiment may be omitted.

In operation S404, the vector determiner 222 determines the direction and speed of scrolling. In the first embodiment, it is regarded that the instruction to start scrolling ends when the user withdraws his finger from the touch panel. In the second embodiment, the vector determiner 222 determines, when the user stops his finger for a predetermined period at a certain location, that the instruction to start scrolling ends. And it is regarded that the time when instruction to start scrolling ends is a point of a time traced back by the predetermined period. Thereafter, when the user further moves his finger, it is regarded that a new instruction to start scrolling begins, and the direction and speed of scrolling are determined again.

In operation S406, the basic update determiner 224 determines the basic updated location of the display area in accordance with the determined direction and speed of scrolling.

In operation S408, the attractive data detector 110 detects attractive data included in the display information, and determines the location of the attractive data in the spread data.

In operation S410, the attractive force calculator 226 calculates an attractive force caused by detected attractive data. The intensity detector 1030 obtains the value, included in the input information, of intensity of pressing the touch panel. The attractive force calculator 226 changes the calculated value of the attractive force, in accordance with the value of intensity of pressing the touch panel. It is preferable to set the value of the attractive force smaller as the value of intensity of pressing the touch panel becomes stronger. For example, the value of the attractive force may be set so as to be inversely proportional to the value of intensity of pressing the touch panel.

In operation S412, the updated location corrector 228 corrects the location of the updated display area in accordance with the changed value of the attractive force.

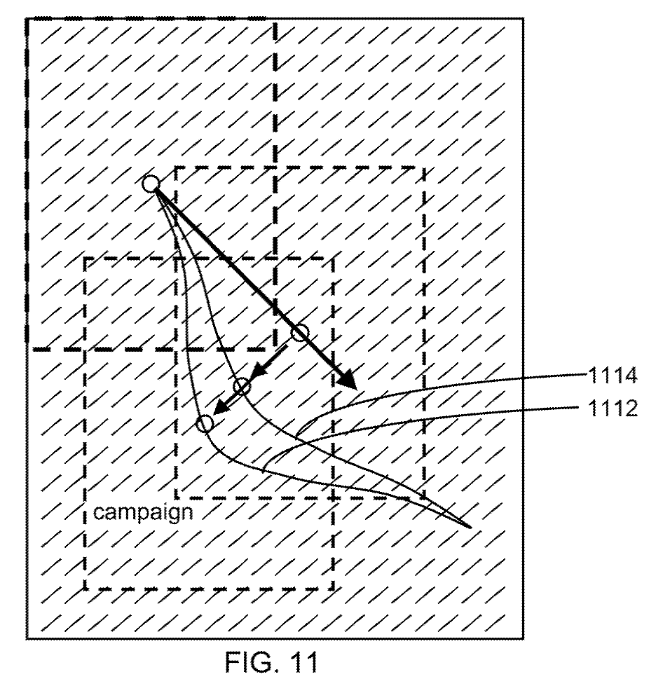

Thus, the user's strong press on the touch panel may control the orbit of scrolling to deviate in the direction of specific attractive data. FIG. 11 is a diagram illustrating an example of a process of correcting an updated location executed by the information browse apparatus according to an embodiment of the invention. Assuming that a scroll orbit 1112 is obtained when the user presses the touch panel with a certain intensity, a scroll orbit 1114 may be obtained in the case where the user presses the touch panel with a greater intensity.

By providing a threshold value to the intensity of pressing the touch panel, the attractive force may be cancelled when the touch panel is pressed with a force of an intensity exceeding the threshold value. In this case, the scrolling is executed by the direction and speed determined in operation S404 without being influenced by the attractive force. Further, the attractive force from the attractive data may be ignored in the subsequent determination of the direction and speed.

As discussed above, according to the second embodiment, since the deviation of the orbit of scrolling may be controlled by the user's instruction, such scrolling may be possible that needless information for the user may be difficult to be displayed. By changing the variation of the orbit of scrolling in response to the intensity of pressing the touch panel with the user's finger or the touch pen, the user may adjust, while operating for scrolling, the level of attraction or repulsion of the attractive data in accordance with the will or taste of the user.

The attractive force is changed in accordance with the intensity of pressing the touch panel as input information in the second embodiment. However, any input information may be used as far as the intensity may be distinguished.

Further, in the second embodiment, it is assumed that automatic scrolling starts upon receiving the instruction to start scrolling from the user. However, a display content may be scrolled along with the movement of the user's finger instead of the automatic scrolling.

Further, a parameter of an important degree may be added to the attractive data to calculate the value of the attractive force. For example, the value of the attractive force is set to be proportional to the important degree. In the aforementioned case where the attractive force is canceled, the attractive force may be weakened in the subsequent operations by lowering the important degree (for example, reducing by half).

The information browse apparatus according to the embodiments of the invention may be executed also as a hardware and as a software of a computer. For example, the information browse apparatus 100 may be realized by providing a program that causes a computer to execute the functions of the input unit, the display unit, the virtual screen spreader, the attractive data detector, the scroll processor, the data clipper, and the controller, and by loading the program into a memory of a computer to execute the program.

The components of the information browse apparatus according to the embodiments of the invention may be provided in any combination. A plurality of components may be provided by one member. Alternatively, one component may be composed of a plurality of members.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the invention have been described in detail, it should be understood that the various changes, substitutions, and alterations could be made hereto without departing from the spirit and scope of the invention.

What is claimed is:

1. An information browse apparatus for displaying information to be browsed, the information browse apparatus comprising:
an attractive data detector that detects attractive data preliminarily specified and a location of the attractive data within spread data to be displayed on a virtual screen supposed for display information of the information to be browsed;
a display unit that displays partial data of the spread data on a display screen smaller than the virtual screen, the partial data being the spread data on a display area corresponding to a screen size of the display screen;
a scroll processor that
determines a direction and speed of scrolling in response to a scroll instruction to the information displayed on the display unit,
determines a basic updated location of an updated display area in accordance with the direction and speed of scrolling, the updated display area replacing a current display area, the spread data on the current display area being currently displayed, and
determines a corrected updated location in accordance with the location of the attractive data and the basic updated location; and
a data clipper that clips, in accordance with the corrected updated location, the partial data of the spread data to be displayed on the display unit.

2. The information browse apparatus according to claim 1, further comprising:
an input unit that receives input information input from a user,
wherein
the scroll processor determines the corrected updated location in accordance with the input information as well as the location of the attractive data and the basic updated location.

3. The information browse apparatus according to claim 2, wherein
the input information includes intensity information, and
the scroll processor determines the corrected updated location in accordance with the intensity information as well as the location of the attractive data and the basic updated location.

4. A control method for controlling display of information to be browsed, the control method being executed by an information browse apparatus, the control method comprising:
detecting attractive data preliminarily specified and a location of the attractive data within spread data to be displayed on a virtual screen supposed for display information of the information to be browsed;
displaying partial data of the spread data on a display screen smaller than the virtual screen, the partial data being the spread data on a display area corresponding to a screen size of the display screen;
determining a direction and speed of scrolling in response to a scroll instruction to the information displayed on a display unit;
determining a basic updated location of an updated display area in accordance with the direction and speed of scrolling, the updated display area replacing a current display area, the spread data on the current display area being currently displayed;
determining, by the information browse apparatus, a corrected updated location in accordance with the location of the attractive data and the basic updated location; and
clipping, in accordance with the corrected updated location, the partial data of the spread data to be displayed on the display unit.

5. The control method according to claim 4, further comprising:
receiving input information input from a user,
wherein
the information browse apparatus determines the corrected updated location in accordance with the input information as well as the location of the attractive data and the basic updated location.

6. The control method according to claim 5, wherein
the input information includes intensity information, and
the information browse apparatus determines the corrected updated location in accordance with the intensity information as well as the location of the attractive data and the basic updated location.

7. A computer-readable medium storing a program to control display of information to be browsed, the program causing a computer to execute:
detecting attractive data preliminarily specified and a location of the attractive data within spread data to be displayed on a virtual screen supposed for display information of the information to be browsed,
displaying partial data of the spread data on a display screen smaller than the virtual screen, the partial data being the spread data on a display area corresponding to a screen size of the display screen,
determining a direction and speed of scrolling in response to a scroll instruction to the information displayed on a display unit,
determining a basic updated location of an updated display area in accordance with the direction and speed of scrolling, the updated display area replacing a current display area, the spread data on the current display area being currently displayed,
determining a corrected updated location in accordance with the location of the attractive data and the basic updated location, and
clipping, in accordance with the corrected updated location, the partial data of the spread data to be displayed on the display unit.

8. The computer-readable medium according to claim 7, the program further causing the computer to execute:
receiving input information input from a user,
wherein
the information browse apparatus determines the corrected updated location in accordance with the input information as well as the location of the attractive data and the basic updated location.

9. The computer-readable medium according to claim 8, wherein
the input information includes intensity information, and
the information browse apparatus determines the corrected updated location in accordance with the intensity information as well as the location of the attractive data and the basic updated location.
